(19) United States
(12) Patent Application Publication
(10) Pub. No.: US 2016/0240869 A1
(43) Pub. Date: Aug. 18, 2016

(54) Motor Vehicle, Method for Controlling a Fill Level of a Water Tank in a Motor Vehicle that Comprises a Fuel Cell System, and Use of Signals and/or Data of a Motor Vehicle State and/or of a Motor Vehicle Environment

(71) Applicant: Bayerische Motoren Werke Aktiengesellschaft, Muenchen (DE)

(72) Inventors: Max ESCHENBACH, Muenchen (DE); Juergen THYROFF, Dachau (DE); Johannes SCHMID, Muenchen (DE)

(21) Appl. No.: 15/141,192

(22) Filed: Apr. 28, 2016

Related U.S. Application Data
(63) Continuation of application No. PCT/EP2014/071462, filed on Oct. 7, 2014.

(30) Foreign Application Priority Data
Oct. 28, 2013 (DE) 10 2013 221 876.1

(51) Int. Cl. H01M 8/04029; H01M 8/04701; H01M 8/24; B60L 11/18

(52) U.S. Cl. CPC H01M 8/04029; B60L 11/1892; H01M 8/04701; H01M 8/24; H01M 2250/20

(57) ABSTRACT

A motor vehicle including a fuel cell system having multiple fuel cells that are stacked into a fuel cell stack and a first water cooling circuit for cooling the fuel cell stack. The first water cooling circuit has a water tank system with a first water tank, a first water delivery device that is arranged between the first water tank and the fuel cell stack and a water separator that is arranged between the fuel cell stack and the first water tank. The fuel cell system furthermore has a first control device. The first control device is equipped to regulate a filling level of the first water tank as a function of signals and/or data of the motor vehicle state and/or of the motor vehicle surroundings.

### CROSS REFERENCE TO RELATED APPLICATIONS

This application is a continuation of PCT International Application No. PCT/EP2014/071462, filed Oct. 7, 2014, which claims priority under 35 U.S.C. §119 from German Patent Application No. 10 2013 221 876.1, filed Oct. 28, 2013, the entire disclosures of which are herein expressly incorporated by reference.

### BACKGROUND AND SUMMARY OF THE INVENTION

The present invention relates to a motor vehicle having a fuel cell system and to a method for the energy-efficient regulation of a filling level of a water tank in the fuel cell system of the motor vehicle. The invention, furthermore, also relates to use of signals and/or data of a motor vehicle state and/or motor vehicle surroundings in a motor vehicle having the fuel cell system.

In motor vehicles which are driven by fuel cells or contain a fuel cell system, water is generated through the fuel cell reaction. On the other hand, water is also used for cooling the fuel cell system. For this reason, fuel cell systems are known which include a closed cooling circuit, which discharges water formed as steam from the fuel cells, separates liquid water from this and then again uses the condensed water for cooling. A water separation in this case is effected as a function of certain fuel cell system parameters such as the pH value of the water in the cooling circuit, a solids proportion in the water of the water cooling circuit and the like. The condensed water is mostly intermediately-stored in a water tank and delivered from the water tank when required. As soon as a filling level of the water in the water tank undershoots a set value, usually 75% of the total filling volume of the water tank, water is separated. The water separation is thus not energetically optimized. However, a non-optimized cooling management of a motor vehicle fuel cell system can, because of the complex interaction with the vehicle operating strategy, disturb the subjective perception of a motor vehicle user with respect to acoustic, thermal and energetic (drive output) aspects.

Starting out from this prior art it is therefore an object of the present invention to provide a motor vehicle having a fuel cell system which is characterized by an energy-efficiently controlled water separation and water storage. Furthermore, an object of the present invention is to provide a method for regulating a filling level of a first water tank in a motor vehicle having the fuel cell system, by which a separation rate of water, a separation time or even a discharge rate of water can be energy-efficiently controlled. It is also an object of the invention, furthermore, to provide a usage of signals and/or data of a motor vehicle state and/or of motor vehicle surroundings in a motor vehicle having the fuel cell system.

These and other objects are achieved according to the invention by a motor vehicle having a fuel cell system with multiple fuel cells stacked to form a fuel cell stack and a first water cooling circuit for cooling the fuel cell stack. The first water cooling circuit includes a water tank system with a first water tank, a first water delivery device that is arranged between the first water tank and the fuel cell stack, and a water separator that is arranged between the fuel cell stack and the first water tank. The fuel cell system furthermore includes a first control device, wherein the first control device is equipped to regulate a filling level of the first water tank as a function of signals and/or data of the motor vehicle state and/or of the motor vehicle surroundings. A regulation of the filling level of the first water tank, and thus also a regulation of a water separation rate, are essential for an adequate cooling of the fuel cell system. In order to separate cooling water, the water separator includes a cooling device. Alternatively, a cooling device can also be arranged in the water cooling circuit between the fuel cell stack and the water separator.

According to the invention, the filling level of the first water tank is not controlled as a function of data from the fuel cell system, but rather, in other words, based on signals and data from the periphery of the fuel cell system. Signals and data of the motor vehicle state and/or the motor vehicle surroundings in this case include operating state data and peripheral data of the motor vehicle which are current and known from the history, as well as to be expected in the future. Since the motor vehicle has a decisive influence on the output demanded at the fuel cell system and thus also on a cooling output of the fuel cell system, a regulation of the filling level of the first water tank can take place in a predictive and thus energy-efficient manner by using signals and/or data of the motor vehicle state and/or of the motor vehicle surroundings. The first water tank is thus always adequately filled with water so that any output demanded at the fuel cell system can be provided, without the fuel cell system suffering damage through lack of cooling. A water separation and water storage in vehicle states in which the water separation and storage take place only inefficiently because of the system, for example with the help of a high radiator fan output, can be effectively prevented. Furthermore, during motor vehicle operation, when a minimum filling level is reached in the first water tank, the filling level in the first water tank does not have to be immediately regulated by condensing water without taking into account fuel cell system periphery data as is conventionally the case. Here, a regulation of the filling level based on signals and/or data of the motor vehicle state and/or of the motor vehicle surroundings according to the invention offers the further advantage of delaying a water separation for increasing the filling level in the first water tank to a later time when, according to the motor vehicle prediction, a vehicle state can be achieved in the short to medium term which makes possible an energy-efficient and rapid increase of the filling level in the first water tank. With given water tank volume, the operating window is thereby effectively enlarged or the minimum necessary filling level quantity in the first water tank lowered, which improves the flexibility of the control of the fuel cell system and thus provides a water separation rate, a separation time and a water discharge rate that is not below default filling level parameters of the water tank, but as a function of a positive energy balance of the overall system. Because of this, a range extension of the motor vehicle with given tank or battery capacity can also be achieved.

The motor vehicle according to the invention is not restricted in detail and also includes autonomous or part-autonomous motor vehicles. The part-autonomous motor vehicles include, among others, motor vehicles with driver assistance and/or speed regulation system (cruise control).

According to an advantageous further development of the motor vehicle according to the invention, the motor vehicle includes at least one navigation system, wherein the signals and/or data of the motor vehicle state and/or of the motor vehicle surroundings are data provided by the navigation system. The navigation system need not be a permanent installation of the motor vehicle. It is sufficient when the navigation system emits data to the first control device at least temporarily. Navigation-based parameters in terms of the invention include, for example, supply position, route and traffic information. By way of the data obtained from the navigation installation, critical positions and zones to be traveled by the motor vehicle in the future can be defined and determined which, for example, require a high output of the fuel cell system and thus also a high cooling output and an adequate filling level in the first water tank. A regulation of the filling level based on navigation-based signals and data is thus time-optimized and energy efficient. For example, the entry into pre-defined zones can be detected via position information from the navigation installation. Because of this, an adaptation of the water separation and storage strategy, which leads to an increase of the water filling level in the first water tank, to special vehicle positions is possible, for example when entering mountain passes via existing road courses, by determining the gradients, curve radii, curve sequences, altitudes and lengths of the climb. The regulation of the filling level and thus also the water separation can thus be adapted so that at the end of a mountain pass the filling level is at a low level. Consequently, while driving, less water has to be separated, which when traveling uphill puts decisively less load on the cooling system of the fuel cell system. Furthermore, by way of congestion reports the filling level regulation of the first water tank and thus the water separation in slow-moving or almost stationary traffic at high ambient temperatures can be reduced to a minimum in order to minimize the acoustically perceptible switching-on of the motor vehicle radiator fan. In cold times of the year, the formation of condensation clouds near the vehicle can be additionally reduced or even prevented through a higher separation rate. In addition to this, comprehensive information, in the case of active target control of the navigation installation, regarding routes to be traveled and their course can be made available. The prediction of the water requirement for cooling the fuel cell system that is made possible because of this makes possible a requirement-optimized and energetically optimized water separation and thus an energy-efficient regulation of the filling level of the first water tank. It is thus known for example when the vehicle is or will be in route sections with high output requirements in which the water separation can be reduced and when the vehicle is or will be in route sections in which the water separation is energetically more favorable. A regulation of the filling level of the first water tank can thus take place as a function of a route traveling cycle just passed through and/or to be expected taking into account the traveling situation known from the history and the current and the expected traveling situation.

The data provided by the navigation system are particularly advantageously traveling route parameters such as, for example, route parameters, a route course or a target control since the expected requirements of cooling medium can thereby be best estimated and optimally controlled in terms of time and energy.

Another advantageous further development provides that the motor vehicle includes at least one sensor, wherein the signals and/or data of the motor vehicle state and/or of the motor vehicle surroundings are data that are provided by the sensor. Suitable sensors in this case are those using operative parameters, vehicle-specific sensor systems or signals from input elements (switches) and include, by way of example, sensors for determining gradients of a traveling route, driving dynamic sensors, transverse acceleration sensors, sensors for detecting the pedal dynamics, sensors for detecting an overtaking maneuver, driving event switches, air humidity sensors, sensors for sun irradiation, temperature sensors, air pressure sensors, speedometers, and sensors for determining the mass flow through the water cooling circuit, detection for aerodynamic flaps and extendable rear spoilers.

Furthermore, the first control device can also be equipped to analyze the driving behavior and assign it to a motor vehicle driver. An assignment to a motor vehicle driver, however, can also take place by way of a person identification, for example a key encoding, a seat memory or a face recognition. From the data for the person identification and the assignment of the driving behavior to a certain motor vehicle driver resulting from this, certain requirements for the current and the future traveling route can likewise be predicted. This also applies to so-called commuter routes, i.e. route courses which are frequently repeated. By way of sensor-specific and also motor vehicle driver-specific signals and/or data, an improved prediction of the cooling water requirement is possible so that a water separation and filling level regulation of the first water tank can take place in an energy-efficient manner.

In particular, the water separation requirement and thus a filling level regulation of the first water tank can be particularly favorably predicted and/or optimized in particular through a combination of person recognition, current navigation installation data and/or stored traveling routes.

Further advantageously, the motor vehicle according to the invention includes at least one wireless communication device, wherein the data of the motor vehicle state and/or of the motor vehicle surroundings are data provided by the wireless communication device. The wireless communication device need not be a permanent installation of the motor vehicle. It is sufficient when the wireless communication device outputs data to the first control device at least temporarily. By using data of a wireless communication device, route parameters, output and time requirements because of an adapted driving behavior can be determined in a targeted manner. For example, events, mass gatherings and the like which geographically are located within the surroundings of the traveling route can thus be detected and a filling level regulation of the first water tank can be particularly favorably regulated as a function of the expected changed driving behavior. Data provided by the wireless communication device include current data, data known from the history and data to be expected in the future, such as for example dates, utility vehicle prohibitions, holiday periods, rush hours, weather predictions, seasons, a geographical position, GPS data and the like. For example, a current and/or future requirement of an air conditioner and/or a night-time temperature to be expected can be provided for example by way of weather data, such as air pressure data, temperature data, air humidity data, data regarding the sun irradiation and the like. If the night-time temperature to be expected is within the minus temperature range, the filling level of the first water tank can be reduced for example or the water tank completely emptied in order to prevent frost damage in the cooling water circuit. In this way, emptying the tank can also be additionally carried out before an intended motor vehicle parking space is reached in order to avoid water puddles and possibly iced-up areas in the motor vehicle parking space. Regarding the incorporation of current and/or forecast weather data, a filling level regulation of the first water tank can thus take place highly effectively and in a manner that prevents damage. For example, a separation of water in the case of rain or high air humidity can be carried out in a more energy-efficient manner. Determining the time of emptying the water tank can also be adapted to suit the weather conditions as needed.

Further advantageously, the first control device is equipped to regulate a filling level of the first water tank as a function of signals and/or data of the fuel cell system. By taking into account fuel cell system-specific signals and/or data, an additional optimization of the filling level of the first water tank is made possible. Suitable data include an electrical conductivity, a pH value, a solids content of the cooling water, a temperature in the cooling water circuit, a rate of delivery of the first water delivery device, water discharged from the fuel cell system and the like.

Alternatively to the preceding further development, the fuel cell system can also include a second control device, wherein the water tank system has a second water tank that is connected to the first water tank by a water line. The second water tank is arranged between the first water tank, the water separator and the first water delivery device. The water line has a second water delivery device. The second control device is equipped to regulate a filling level of the second water tank as a function of signals and/or data of the fuel cell system. By connecting the first water tank to the second water tank by way of the water line, both the first water tank and also the second water tank are arranged between the water separator and the first water delivery device. Thus, as a function of the signals and/or data of the motor vehicle state and/or of the motor vehicle surroundings, when the first control device increases the filling level of the first water tank, water is correspondingly withdrawn from the second water tank. By lowering the filling level in the second water tank, a set filling level is undershot there and further water immediately separated and fed to the second water tank. The second water tank however can be serviced from the first water tank as additional tank volume especially in the case of low water requirements so that a water separation can be postponed to particularly energy-optimized times later on.

According to another advantageous further development, the second water delivery device includes at least one pump and/or one mammoth pump and/or a water delivery device which utilizes pressure differences and/or a water jet pump and/or a pump with a return flow line. Because of this, water transport from the second water tank into the first water tank can take place simply with only minor energy expenditure also as a function of an arrangement of the water tanks relative to one another.

Further advantageously, the fuel cell system includes at least one second cooling circuit. Because of this, a more efficient and faster water separation is achieved.

Further advantageously, the motor vehicle according to the invention is characterized in that the first control device is equipped to lower or raise a filling level of the first water tank as a function of signals and/or data of the motor vehicle state and/or of the motor vehicle surroundings. By raising the filling level of the first water tank, the fuel cell system can be optimally prepared for output requirements to be expected. In addition to this, a formation of steam clouds, in particular in winter, and frost damage in the water cooling circuit can be minimized by lowering the filling level in the first water tank. In particular, a predictive water tank emptying can be carried out for example outside an intended motor vehicle parking space in order to avoid water puddles there.

Likewise, a method for regulating a filling level of a first water tank in a motor vehicle is described. The motor vehicle in this case includes a fuel cell system with multiple fuel cells stacked to form a fuel cell stack and a first water cooling circuit for cooling the fuel cell stack. The first water cooling circuit includes a water tank system with a first water tank, a first water delivery device that is arranged between the first water tank and the fuel cell stack, and a water separator that is arranged between the fuel cell stack and the first water tank. The method is characterized by the step of regulating the filling level of the first water tank as a function of signals and/or data of the motor vehicle state and/or of the motor vehicle surroundings. By regulating the filling level of the first water tank as a function of signals and/or data of the motor vehicle state and/or of the motor vehicle surroundings, a water separation rate, a separation time and/or a water discharge rate can be controlled in an energy-efficient manner. According to the method, signals and/or data of the motor vehicle state and/or of the motor vehicle surroundings include current signals and data, known historical operating state data and operating state data to be expected in the future and peripheral data of the motor vehicle.

It is noted that the method according to the invention and its further developments are suitable for use in the motor vehicle according to the invention. Concerning the method according to the invention, reference is therefore complementarily made to the embodiments regarding the motor vehicle according to the invention and its advantageous further developments. For the abovementioned reasons and including the already described effects and advantages, energy-optimized water filling level regulation in the first water tank can be carried out by way of the method.

The advantages, advantageous effects and further developments presented for the motor vehicle according to the invention can also be applied to the method according to the invention for regulating a filling level of a first water tank in a motor vehicle having a fuel cell system.

According to an advantageous further development of the method, the signals and/or data of the motor vehicle state and/or of the motor vehicle surroundings are provided by a navigation system and/or a sensor and/or a wireless communication device. This makes possible a particularly energy-efficient regulation of the filling level of the first water tank by predicting an output and thus cooling requirement of the fuel cell system to be expected.

Further advantageously, the method includes the step of regulating a filling level of the first water tank as a function of signals and/or data of the fuel cell system. Because of this, an additional optimization of the filling level of the first water tank can be made possible.

Further advantageously, the fuel cell system has a second control device and the water tank system a second water tank that is connected to the first water tank by a water line. The second water tank is arranged between the first water tank, the water separator and the first water delivery device. The water line includes a second water delivery device. By connecting the first water tank to the second water tank by way of the water line, both the first water tank and also the second water tank are arranged between the water separator and the first water delivery device. This further development of the method is characterized by the step of regulating a filling level of the second water tank as a function of signals and/or data of the fuel cell system. Thus, the second water tank, in the case of minor requirements of water from the first water tank, can be used as additional tank volume so that a water separation can take place at particularly energy-optimized times later on.

Further advantageously, the filling level of the first water tank is lowered or raised as a function of the motor vehicle state and/or of the motor vehicle surroundings. Thus, not only can the fuel cell system be optimally prepared for output requirements to be expected at energy-optimized times by suitably raising the filling level of the first water tank, but also in particular a formation of steam clouds in winter and frost damage in the water cooling circuit can be prevented by lowering the filling level in the first water tank.

Likewise according to the invention, a use of signals and/or data of a motor vehicle state and/or of motor vehicle surroundings that are current, known from the history and expected in the future is described for regulating a filling level of a water tank of a fuel cell system, wherein the fuel cell system is arranged on or in a motor vehicle. The motor vehicle according to the invention also includes autonomous or part-autonomous motor vehicles, i.e. such as those that include for example a driver assistance and/or a speed control system (cruise control).

Because of the solutions according to the inventions and their further developments, the following advantages are obtained in particular:

the motor vehicle according to the invention is characterized by an energy-efficient water separation and thus filling level regulation of the first water tank;

negative interactions with the operating strategy of the remaining components of the motor vehicle are reduced;

the number of malfunctions or output restrictions due to cooling is reduced.

the motor vehicle acoustics are improved; and

by way of a second water tank, an additional cooling water volume can be provided.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a fuel cell system for a motor vehicle according to a first embodiment of the invention;

FIG. 2 is a schematic view of a fuel cell system for a motor vehicle according to a second embodiment of the invention; and

FIG. 3 is a schematic view of a fuel cell system for a motor vehicle according to a third embodiment of the invention.

### DETAILED DESCRIPTION OF THE DRAWINGS

The present invention is explained in detail by way of three exemplary embodiments. In the figures, only the parts of the fuel cell system that are of interest here are shown; all remaining elements have been omitted for the sake of clarity. Furthermore, the same reference characters relate to the same components.

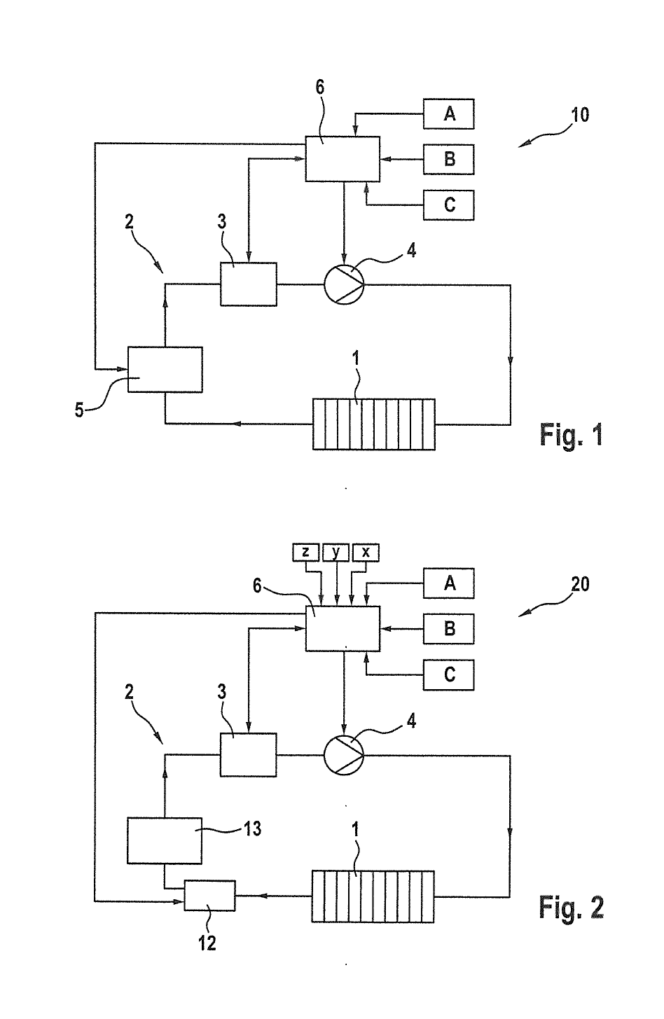

In detail, FIG. 1 shows a fuel cell system 10 for a motor vehicle according to a first advantageous embodiment of the invention. The fuel cell system 10 includes a fuel cell stack 1 with multiple, stacked fuel cells and a first water cooling circuit 2 for cooling the fuel cell stack 1. The first water cooling circuit 2 has a water tank system with a first water tank 3, a first water delivery device 4 arranged between the first water tank 3 and the fuel cell stack 1 and a water separator 5 that is arranged between the fuel cell stack 1 and the first water tank 3.

The water separator 5 is equipped to condense water in the form of steam issuing from the fuel cell stack 1 and, for this purpose, includes a cooling device. Condensed, liquid water is then stored in the first water tank 3, the filling level of which is thus increased by the water separation, and is ready for cooling the fuel cell stack 1.

Furthermore, the fuel cell system 10 includes a first control device 6. Installations which pass data from the fuel cell periphery and thus signals and/or data of the motor vehicle state and/or of the motor vehicle surroundings on to the control device 6 are connected to the first control device 6. For example, these installations comprise a navigation system A, a sensor B and a wireless communication device C. Other or additional installations can be provided. Based on the signals and/or data provided by the installations A, B and C, i.e. signals and/or data of the motor vehicle state and/or of the motor vehicle surroundings that are current, known from the history and to be expected in the future, the first control device 6 is equipped to regulate a filling level of the first water tank 3.

In order to regulate a filling level in the first water tank 3, the first control device 6 controls both the water separation of the water separator 5, i.e. in particular the cooling device, and the first water delivery device 4. By suitable controlling, the filling level in the first water tank 3 can thus be raised or lowered by the first control device 6.

The water separation thus takes place in an energy-efficient manner and takes place as a function of a motor vehicle state prediction determined from the data and signals of the installations A, B and C. If, for example, an entering of the motor vehicle into a mountain pass is determined by way of the navigation system A and/or via equivalent data from the sensor B, a further water separation by the water separator 5 for example on passing over the mountain pass can be initiated with adequate filling level in the first water tank 3. As a result, during the uphill drive the cooling system of the fuel cell system 10 is subjected to less load and the water separation and thus filling level regulation of the water tank 3 are postponed to a later and thus energy-optimized time.

FIG. 2 shows a fuel cell system 20 for a motor vehicle according to a second advantageous embodiment of the invention. The fuel cell system 20 differs from the fuel cell system 10 from FIG. 1 in that the water separator 13 does not have a cooling device. A cooling device 12 is instead provided in the cooling water circuit 2 between the fuel cell stack 1 and the water separator 13.

As a second distinction from the fuel cell system 10 from FIG. 1, further installations are connected to the first control device 6 in FIG. 2, which for example include a temperature sensor X, a pH measurement device Y and a solids measurement device Z. The installations X, Y and Z supply data of the fuel cell system 20 to the first control device 6. By taking into account the fuel cell system-specific signals and/or data of the installations X, Y and Z, an additional optimization of the filling level of the first water tank is made possible.

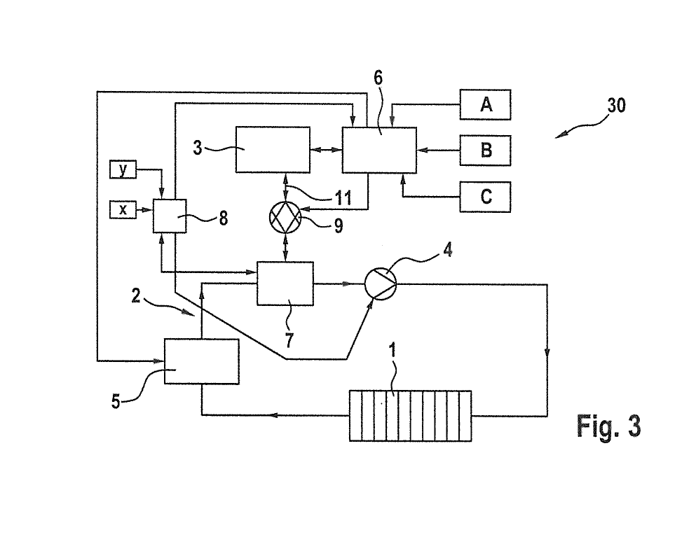

FIG. 3 shows a fuel cell system 30 for a motor vehicle according to a third advantageous embodiment of the invention. The fuel cell system 30 differs from the fuel cell system 10 from FIG. 1 in that the water tank system has a second water tank 7 that is connected to the first water tank 3 by a water line 11, wherein the second water tank 7 is arranged between the first water tank 3, the water separator 5 and the first water delivery device 4. In other words, the first water tank 3 and the second water tank 7 are thus arranged between the water separator 5 and the first water delivery device 4. The water line 11 includes a second water delivery device 9, by which water can be delivered from the first water tank 3 into the second water tank 7 and vice versa.

The fuel cell system 30 furthermore includes a second control device 8 which is in connection with the second water tank 7 and the first control device 6. The second control device 8 is connected to two installations, for example a temperature sensor X and a pH measuring device Y. The installations X and Y supply data of the fuel cell system 30 to the second control device 8 which consequently regulates the filling level of the second water tank 7 as a function of signals and/or data of the fuel cell system.

If the first control device 6 is now supplied with data and/or signals of the navigation system A, the sensor B and/or the wireless communication device C, which cause a high output demanded from the fuel cell system 30 to be expected, for example because the imminent route course provides a mountain pass, water can be delivered for replenishment from the second water tank 7 by the second water delivery device 9 via the water line 11 into the first water tank 3 even when the filling level of the first water tank 3 is not adequate for the high cooling output of the system to be expected then and a renewed water separation by the water separator 5 can be postponed to an energywise more favorable time, that is after passing-through the mountain pass. The water tank volume of the first water tank 3 is thereby enlarged by the volume of the second water tank 7.

The preceding description of the present invention only serves for illustrative purposes and not for the purpose of restricting the invention. Within the scope of the invention, various changes and modifications are possible without leaving the scope of the invention and its equivalents.

List of reference characters:
1 Fuel cell stack
2 First water cooling circuit
3 First water tank
4 First water delivery device
5 Water separator
6 First control device
7 Second water tank
8 Second control device
9 Second water delivery device
10, 20, 30 Fuel cell system
11 Water line
12 Cooling device
13 Water separator
A Navigation system
B Sensor
C Wireless communication device
X Temperature sensor
Y pH measurement device
Z Solid measurement device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

What is claimed is:

1. A motor vehicle, comprising:
a fuel cell system comprising a plurality of fuel cells stacked to form a fuel cell stack and a first water cooling circuit configured to cool the fuel cell stack, wherein
the first water cooling circuit comprises a water tank system having a first water tank, a first water delivery device arranged between the first water tank and the fuel cell stack, and a water separator arranged between the fuel cell stack and the first water tank,
the fuel cell system further comprising a first control device operatively configured to regulate a filling level of the first water tank as a function of signals and/or data of a state of the motor vehicle and/or of surroundings of the motor vehicle; and
a navigation system operatively configured to provide the signals and/or the data of the motor vehicle state and/or of the motor vehicle surroundings.

2. The motor vehicle according to claim 1, wherein the navigation system provides travel route parameters.

3. The motor vehicle according to claim 1, further comprising:
at least one sensor configured to provide the signals and/or the data of the motor vehicle state and/or of the motor vehicle surroundings.

4. The motor vehicle according to claim 3, further comprising at least one wireless communication device configured to provide the signals and/or the data of the motor vehicle state and/or of the motor vehicle surroundings.

5. The motor vehicle according to claim 1, further comprising at least one wireless communication device configured to provide the signals and/or the data of the motor vehicle state and/or of the motor vehicle surroundings.

6. The motor vehicle according to claim 1, wherein the first control device is further operatively configured to regulate the filling level of the first water tank as a function of signals and/or data of the fuel cell system.

7. The motor vehicle according to claim 1, further comprising:
a second control device of the fuel cell system;
a second water tank of the water tank system, the second water tank being connected to the first water tank via a water line, wherein
the second water tank is arranged between the first water tank, the water separator and the first water delivery device,
the water line includes a second water delivery device, and
the second control device is operatively configured to regulate a filling level of the second water tank as function of signals and/or data of the fuel cell system.

8. The motor vehicle according to claim 4, further comprising:
a second control device of the fuel cell system;
a second water tank of the water tank system, the second water tank being connected to the first water tank via a water line, wherein
the second water tank is arranged between the first water tank, the water separator and the first water delivery device,
the water line includes a second water delivery device, and
the second control device is operatively configured to regulate a filling level of the second water tank as function of signals and/or data of the fuel cell system.

9. The motor vehicle according to claim 7, wherein the second water delivery device comprises a pump and/or a pressure differentiation water delivery device.

10. The motor vehicle according to claim 9, wherein the pump is a mammoth pump, a water jet pump or a pump having a return flow line.

11. The motor vehicle according to claim 1, wherein the fuel cell system comprises at least one second cooling circuit.

12. The motor vehicle according to claim 1, wherein the first control device is further operatively configured to lower or raise the filling level of the first water tank as a function of the signals and/or the data of the motor vehicle state and/or of the motor vehicle surroundings.

13. A method of regulating a filling level of a first water tank in a motor vehicle having a fuel cell system with a plurality of fuel cells stacked to form a fuel cell stack and a first water cooling circuit configured to cool the fuel cell stack, wherein the first water cooling circuit comprises a water tank system having a first water tank, a first water delivery device arranged between the first water tank and the fuel cell stack, and a water separator arranged between the fuel cell stack and the first water tank, wherein the method comprises the acts of:
receiving signals and/or data of a state of the motor vehicle and/or of surroundings of the motor vehicle via one or more of a navigation system, a sensor or a wireless communication device; and
regulating a filling level of the first water tank as a function of the signals and/or the data of the motor vehicle state and/or of the motor vehicle surroundings.

14. The method according to claim 13, further comprising the act of regulating the filling level of the first water tank as a function of signals and/or data of the fuel cell system.

15. The method according to claim 13, wherein the fuel cell system further comprises a second control device and the water tank system comprises a second water tank connected to the first water tank via a water line, the second water tank being arranged between the first water tank, the water separator and the first water delivery device, and the water line having a second water delivery device, wherein the method further comprises the act of:
regulating a filling level of the second water tank as a function of signals and/or data of the fuel cell system.

16. The method according to claim 14, wherein the fuel cell system further comprises a second control device and the water tank system comprises a second water tank connected to the first water tank via a water line, the second water tank being arranged between the first water tank, the water separator and the first water delivery device, and the water line having a second water delivery device, wherein the method further comprises the act of:
regulating a filling level of the second water tank as a function of the signals and/or the data of the fuel cell system.

17. The method according to claim 15, further comprising the act of lowering or raising the filling level of the first water tank as a function of the motor vehicle state and/or of the motor vehicle surroundings.

18. The method according to claim 16, further comprising the act of lowering or raising the filling level of the first water tank as a function of the motor vehicle state and/or of the motor vehicle surroundings.
